(19) United States
(12) Patent Application Publication
(10) Pub. No.: US 2025/0293261 A1
(43) Pub. Date: Sep. 18, 2025

(54) COMPOSITE SUBSTRATE FOR RECHARGEABLE LITHIUM BATTERY AND RECHARGEABLE LITHIUM BATTERY INCLUDING THE COMPOSITE SUBSTRATE

(71) Applicant: SAMSUNG SDI CO., LTD., Gyeonggi-do (KR)

(72) Inventor: Donghyun SHIN, Gyeonggi-do (KR)

(73) Assignee: SAMSUNG SDI CO., LTD., Gyeonggi-do (KR)

(21) Appl. No.: 18/816,679

(22) Filed: Aug. 27, 2024

(30) Foreign Application Priority Data
Mar. 15, 2024 (KR) 10-2024-0036540

(51) Int. Cl. H01M 4/66; H01M 4/02; H01M 10/052

(52) U.S. Cl. CPC H01M 4/667; H01M 4/662; H01M 4/663; H01M 4/668; H01M 10/052; H01M 2004/021

(57) ABSTRACT

Disclosed are composite substrates and rechargeable lithium batteries including the composite substrates. A composite substrate includes a support layer and a coating layer on the support layer. The coating layer includes a carbon material and a hydrogel. The coating layer is configured to contain an electrolyte.

### CROSS-REFERENCE TO RELATED APPLICATION

This U.S. nonprovisional application claims the benefit of priority under 35 U.S.C § 119 to Korean Patent Application No. 10-2024-0036540 filed on Mar. 15, 2024 in the Korean Intellectual Property Office, the disclosure of which is hereby incorporated by reference in its entirety.

### BACKGROUND

The present disclosure relates to a composite substrate for a rechargeable lithium battery, and a rechargeable lithium battery including the composite substrate.

With the increased spread of battery-using electronic devices, such as, e.g., mobile phones, laptop computers, electric vehicles, and the like, there is increasing demand for rechargeable batteries with high energy density and high capacity.

A rechargeable lithium battery typically includes a positive electrode, a negative electrode, and an electrolyte, and the positive and negative electrodes include an active material in which intercalation and deintercalation are possible. The rechargeable lithium battery typically generates electrical energy via oxidation and reduction reactions when lithium ions are intercalated and deintercalated.

### SUMMARY

An example embodiment of the present disclosure includes a composite substrate with desired, advantageous or improved impregnation of an electrolyte and superior ion mobility.

An example embodiment of the present disclosure includes a rechargeable lithium battery including the composite substrate.

According to an example embodiment of the present disclosure, a composite substrate for a rechargeable lithium battery may include a support layer, and a coating layer on the support layer. The coating layer may include a carbon material and a hydrogel. The coating layer may be configured to contain an electrolyte.

According to an example embodiment of the present disclosure, a composite substrate for a rechargeable lithium battery may include a support layer, and a coating layer on the support layer. The coating layer may include a carbon material and a hydrogel. An amount of the carbon material may be about 80 wt % to about 99 wt % relative to 100 wt % of the coating layer. An amount of the hydrogel may be about 0.05 wt % to about 1 wt % relative to 100 wt % of the coating layer.

According to an example embodiment of the present disclosure, a rechargeable lithium battery may include an electrode that includes a composite substrate and an active material layer on the composite substrate. The composite substrate may include a support layer and a coating layer on the support layer. The coating layer may include a carbon material and a hydrogel.

### BRIEF DESCRIPTION OF DRAWINGS

FIG. 1 illustrates a simplified conceptual diagram showing a rechargeable lithium battery according to an example embodiment of the present disclosure.

FIGS. 2 to 5 illustrate simplified diagrams showing a rechargeable lithium battery according to an example embodiment of the present disclosure.

FIG. 6 illustrates a cross-sectional view showing a composite substrate according to an example embodiment of the present disclosure.

FIG. 7 illustrates a cross-sectional view showing an electrode according to an example embodiment of the present disclosure.

FIG. 8 illustrates a graph showing results of cell performance evaluation according to Comparative Example and Embodiment.

### DETAILED DESCRIPTION OF EMBODIMENTS

In order to sufficiently understand the configuration and effect of the present disclosure, some example embodiments of the present disclosure will be described with reference to the accompanying drawings. It should be noted, however, that the present disclosure is not limited to the following example embodiments, and may be implemented in various forms. Rather, the example embodiments are provided only to disclose the present disclosure and let those skilled in the art fully know the scope of the present disclosure.

In this description, it will be understood that, when an element is referred to as being “on” another element, the element can be directly on the other element or intervening elements may be present between therebetween. In the drawings, thicknesses of some components are exaggerated for effectively explaining the technical contents. Like reference numerals refer to like elements throughout the specification.

Unless otherwise specially noted in this description, the expression of singular form may include the expression of plural form. In addition, unless otherwise specially noted, the phrase “A or B” may indicate “A but not B,” “B but not A,” and “A and B.” The terms “comprises/includes” and/or “comprising/including” used in this description do not exclude the presence or addition of one or more other components.

As used herein, the term “combination thereof” may refer to a mixture, a stack, a composite, a copolymer, an alloy, a blend, or a reaction product.

Unless otherwise especially defined in this description, a particle diameter may be an average particle diameter. In addition, a particle diameter indicates an average particle diameter (D₅₀) where a cumulative volume is about 50 volume % in a particle size distribution. The average particle diameter (D₅₀) may be measured by a method widely known to those skilled in the art, for example, by a particle size analyzer, a transmission electron microscope (TEM) image, or a scanning electron microscope (SEM) image. Alternatively, a dynamic light-scattering measurement device is used to perform a data analysis, the number of particles is counted for each particle size range, and then from this, an average particle diameter (D₅₀) value may be obtained through a calculation. A laser scattering method may also be utilized to measure the average particle diameter (D₅₀). In the laser scattering method, a target particle is distributed in a distribution solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

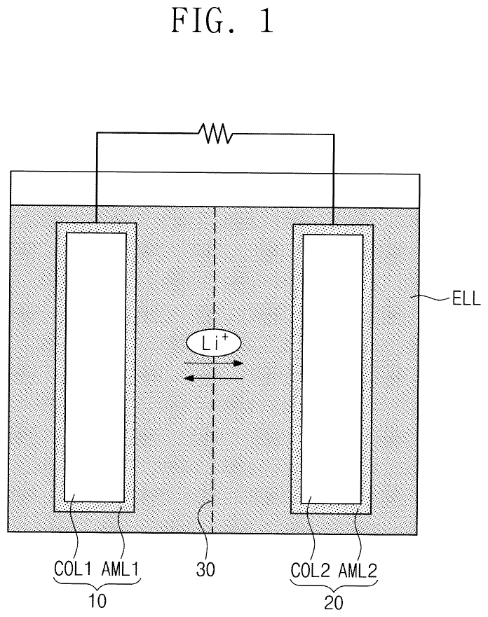

FIG. 1 illustrates a simplified conceptual diagram showing a rechargeable lithium battery according to an example embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and may further include a binder and/or a conductive material.

For example, the positive electrode 10 may further include an additive that may constitute a sacrificial positive electrode.

An amount of the positive electrode active material may range from about 90 wt % to about 99.5 wt % relative to 100 wt % of the positive electrode active material layer AML1. Amounts of the binder and the conductive material may be about 0.5 wt % to about 5 wt % relative to 100 wt % of the positive electrode active material layer AML1.

The binder may improve attachment of positive electrode active material particles to each other, and also improve attachment of the positive electrode active material to the current collector COL1. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may provide an electrode with conductivity, and any suitable conductive material without causing chemical change of a battery may be used as the conductive material to constitute the battery. The conductive material may include, for example, a carbon-based material such as at least one of natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal such as including at least one of cobalt, manganese, nickel, and a combination thereof.

The composite oxide may include lithium transition metal composite oxide, for example, at least lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by at least one of chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}CO_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A is or includes Ni, Co, Mn, or a combination thereof, X is or includes Al, Ni, Co, Mn, Cr, Fe, Mg, Sr, V, a rare-earth element, or a combination thereof, D is or includes O, F, S, P, or a combination thereof, G is or includes Al, Cr, Mn, Fe, Mg, La, Ce, Sr, V, or a combination thereof, and L¹ is or includes Mn, Al, or a combination thereof.

For example, the positive electrode active material may be or include a high nickel-based positive electrode active material having a nickel content of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high nickel-based positive electrode active material may improve capacity and density to lithium secondary batteries.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material.

For example, the negative electrode active material layer AML2 may include a negative electrode active material of about 90 wt % to about 99 wt %, a binder of about 0.5 wt % to about 5 wt %, and a conductive material of about 0 wt % to about 5 wt %.

The binder may improve attachment of negative electrode active material particles to each other, and also improve attachment of the negative electrode active material to the current collector COL2. The binder may include a non-aqueous binder, an aqueous binder, a dry binder, or a combination thereof.

The non-aqueous binder may include at least polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least styrene-butadiene rubber, (meth)acrylated styrene-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is used as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least polytetrafluoroethylene, polyvinylidene fluoride, polyvinylidene fluoride-hexafluoropropylene copolymer, polyethylene oxide, or a combination thereof.

The conductive material may provide an electrode with conductivity, and any suitable conductive material without causing chemical change of a battery may be used as the conductive material to constitute the battery. For example, the conductive material may include a carbon-based material such as at least one of natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

The current collector COL2 may include at least a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, at least crystalline carbon, amorphous carbon, or a combination thereof. For example, the crystalline carbon may include graphite such as non-shaped, sheet-shaped, flake-shaped, sphere-shaped, or fiber-shaped natural or artificial graphite, and the amorphous carbon may include at least one of soft carbon, hard carbon, mesophase pitch carbon, or calcined coke.

The lithium metal alloy may include an alloy of lithium and metal that is at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material, or a Sn-based negative electrode active material. The Si-based negative electrode active material may include at least silicon, silicon-carbon composite, SiOx (0<x<2), Si—Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least Sn, SnO₂, a Sn-based alloy, a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be located between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer on a surface of the core.

The Si-based negative electrode active material or the Sn-based negative electrode active material may be used in combination with a carbon-based negative electrode active material.

### Separator 30

Based on type of the rechargeable lithium battery, the separator 30 may be between the positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, which coating layer includes an organic material, an inorganic material, or a combination thereof.

The porous substrate may be or include a polymer layer including at least one of polyolefin such as, e.g., polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be a copolymer or mixture including two or more of the materials mentioned above.

The organic material may include a polyvinylidenefluoride-based copolymer or a (meth)acrylic copolymer.

The inorganic material may include an inorganic particle that includes at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer, or may be present as a stack of a coating layer including the organic material and a coating layer including an inorganic material.

### Electrolyte ELL

The electrolyte ELL for the rechargeable lithium battery may include, e.g., at least a non-aqueous organic solvent and a lithium salt.

The non-aqueous organic solvent may constitute a medium for transmitting ions that participate in an electrochemical reaction of a battery.

The non-aqueous organic solvent may include at least a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The aprotic solvent may include nitriles such as R-CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be used alone or in a mixture of two or more substances.

In addition, when a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be or include a material that is dissolved in the non-aqueous organic solvent to constitute a supply source of lithium ions in a battery, and plays a role in enabling a basic operation of a rechargeable lithium battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers between 1 to 20), lithium trifluoromethane sulfonate, lithium tetrafluoroethanesulfonate, lithium difluoro(oxalato)borate (LiDFOB), lithium difluorobis(oxalato)phosphate (LiDFBOP), and lithium bis(oxalato)borate (LiBOB)

### Rechargeable Lithium Battery

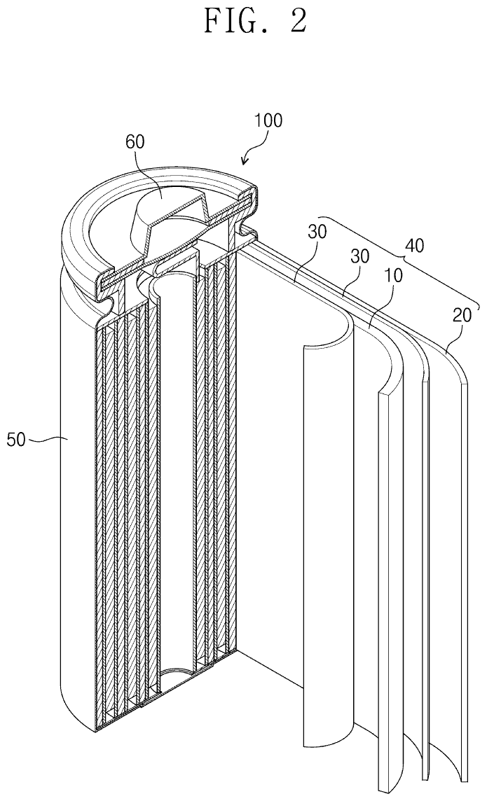

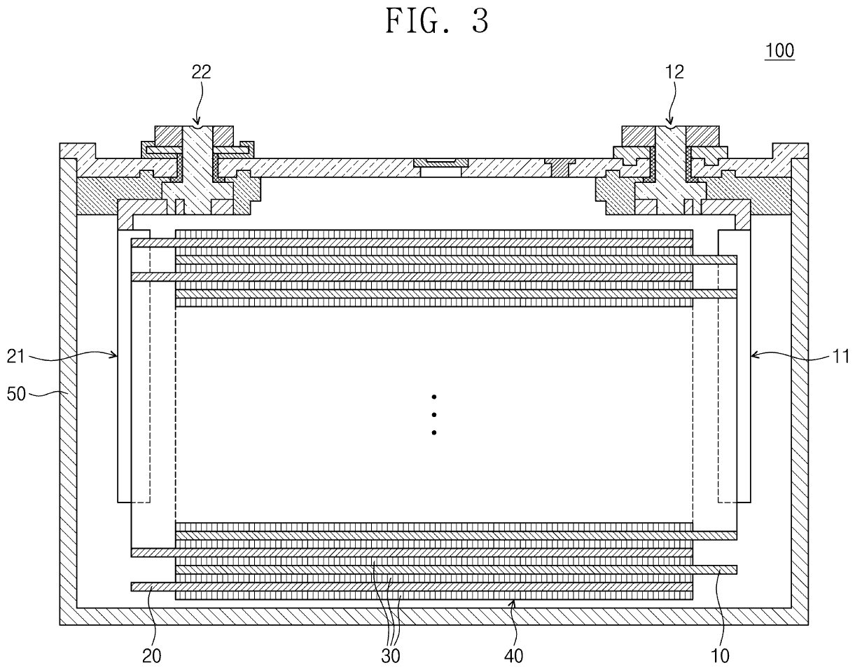

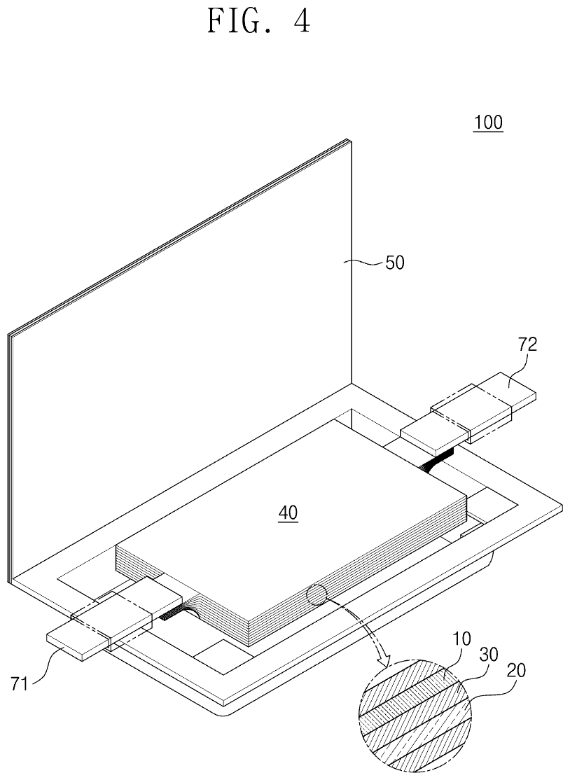

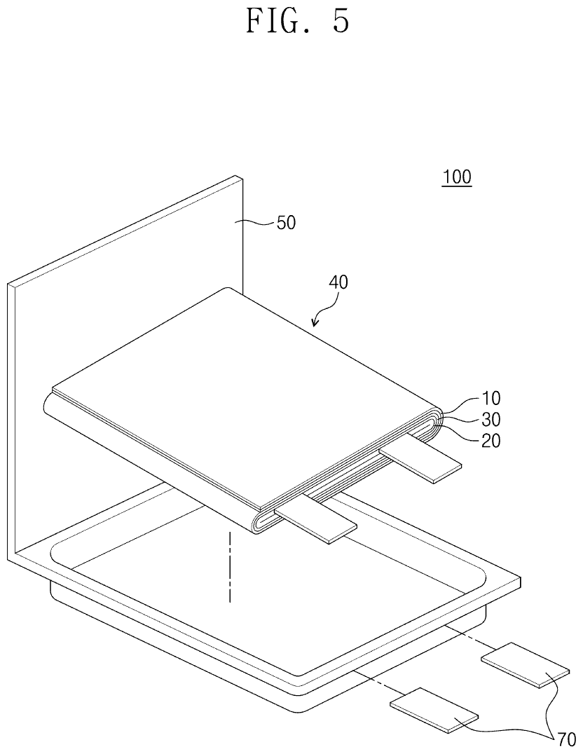

Based on the shape of a rechargeable lithium battery, the rechargeable lithium battery may be classified into cylindrical, prismatic, pouch, and coin battery. In FIGS. 2 to 5 illustrating simplified diagrams showing a rechargeable lithium battery according to an example embodiment, FIG. 2 illustrates a cylindrical battery, FIG. 3 illustrates a prismatic battery, and FIGS. 4 and 5 illustrate pouch-type batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70 illustrated in FIG. 5, or a positive electrode tab 71 and a negative electrode tab 72 illustrated in FIG. 4, which electrode tab 70 constitutes an electrical path for externally inducing a current generated in the electrode assembly 40.

In the following example embodiments of the present disclosure, a detailed description of technical features repetitive to those of the rechargeable lithium battery discussed with reference to FIGS. 1 to 5 will be omitted, and a difference thereof will be discussed in detail.

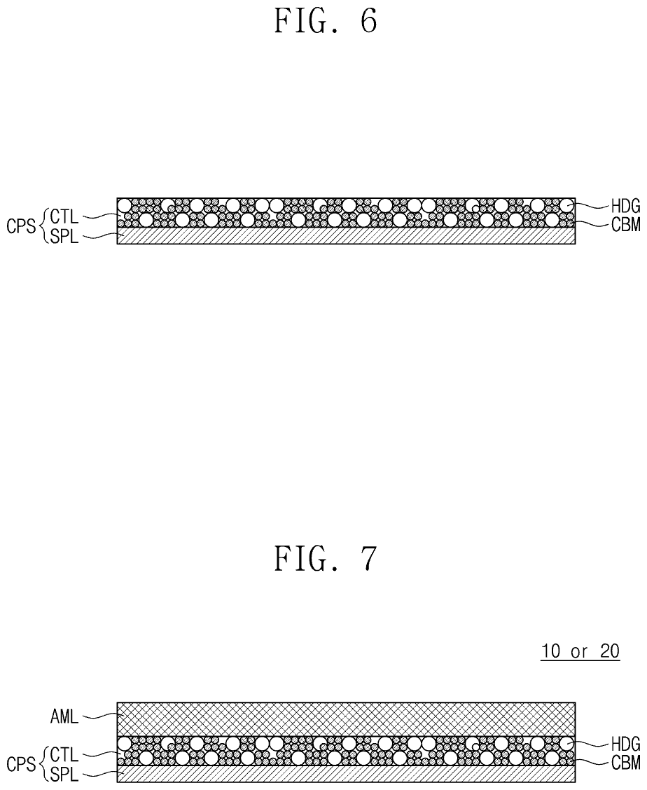

FIG. 6 illustrates a cross-sectional view illustrating a composite substrate according to an example embodiment of the present disclosure.

A composite substrate CPS according to an example embodiment of the present disclosure may be or include the current collector COL1 or COL2 discussed in FIG. 1. In the following description, the current collector COL1 or COL2 may be called the composite substrate CPS.

Referring to FIG. 6, the composite substrate CPS may include a support layer SPL and a coating layer CTL that includes a carbon material CBM and a hydrogel HDG on the support layer SPL.

The support layer SPL may be or include a metal layer. The support layer SPL may include at least one of aluminum, aluminum alloys, copper, copper alloys, nickel, nickel alloys, titanium, titanium alloys, iron, iron alloys, silver, and silver alloys. For example, the support layer SPL may include aluminum.

The support layer SPL may have a shape of foils, films, sheets, meshes, nets, porous structures, foams, and non-woven fabrics. For example, the support layer SPL may have a foil shape.

The coating layer CTL may be a film coated on a surface of the support layer SPL. For example, the coating layer CTL may have a thickness that is greater than that of the support layer SPL.

The coating layer CTL may be coated on the support layer SPL by using, e.g., spin coating, bar coating, gravure coating, roll coating, blade coating, slide die coating, or dipping coating. A dry process may be performed on the coating layer CTL. An oven or hot air may be used in the dry process, but the present disclosure is not particularly limited thereto.

The support layer SPL may have a thickness of about 200 nm to about 20 μm. When the thickness of the support layer SPL is greater than the range above, a battery weight may increase, and as a result a battery energy density may be reduced. When the thickness of the support layer SPL is lower than the range above, the small thickness may induce damage caused by overheating during high-current operation.

The carbon material CBM may include at least one of graphite, carbon black, acetylene black, Ketjen black, carbon fiber, carbon nano-tube, and graphene. For example, the carbon material CBM may be graphite.

The carbon material CBM may have an average particle diameter (D₅₀) of about 0.01 μm to about 1 μm. When the particle size of the carbon material CBM satisfies the range above, the carbon material CBM may be mixed with the hydrogel HDG to form an appropriate ion path in the coating layer CTL. The average particle diameter (D₅₀) may be defined to indicate a particle diameter equivalent to a particle diameter at a cumulative volume of 50% from a smaller particle diameter side in a particle size distribution of the carbon material CBM.

The hydrogel HDG may include a natural or synthetic hydrophilic polymer that is or includes at least one of hyaluronic acid, chitosan, heparin, alginate, fibrin, polyvinyl alcohol, polyethylene glycol, sodium polyacrylate, acrylate polymers, and copolymers thereof. For example, the hydrogel HDG may include an acrylate polymer.

The hydrogel HDG may have an average particle diameter (D₅₀) of about 50 nm to about 500 nm. For example, the hydrogel HDG may have an average particle diameter (D₅₀) of about 100 nm to about 400 nm. The average particle diameter (D₅₀) may be defined to indicate a particle diameter that is equivalent to a particle diameter at a cumulative volume of 50% from a smaller particle diameter side in a particle size distribution of the hydrogel HDG. When the particle size of the hydrogel HDG satisfies the range above, ion mobility in cells may be effectively improved.

The coating layer CTL may contain an electrolyte, e.g., the coating layer CTL may be impregnated by the electrolyte. As the coating layer CTL is added with the hydrogel HDG having electrolyte affinity, the composite substrate CPS may exhibit improved electrolyte impregnation. Thus, the composite substrate CPS may improve in ion mobility. As a result, in the composite substrate CPS for a rechargeable lithium battery according to examples of the present disclosure, the supply of an electrolyte may be increased on a lower portion of a battery active material layer to improve lifetime stability and battery characteristics.

The coating layer CTL may have a thickness of about 1 μm to about 100 μm. For example, the coating layer CTL may have a thickness of about 5 μm to about 20 μm. When the thickness of the coating layer CTL satisfies the range above, ion mobility of batteries may effectively increase.

Although not shown in FIG. 6, the coating layer CTL may further include a binder and a dispersant. For example, the coating layer CTL may include the carbon material CBM, the hydrogel HDG, the binder, and the dispersant.

In examples of the present disclosure, the coating layer CTL may include the carbon material CBM and the hydrogel HDG and may, if necessary, selectively include an additive such as the binder, but it may not be absolutely necessary that the binder be present.

The binder may include, for example, at least polytetrafluoroethylene, polyvinylidene fluoride, polyvinylidene fluoride-hexafluoropropylene copolymer, polyethylene oxide, styrene-butadiene rubber, acrylonitrile-butadiene rubber, fluoro rubber, polyvinyl acetate, nitrocellulose, or combinations thereof.

In the present disclosure, the coating layer CTL may include the carbon material CBM and the hydrogel HDG and may, if necessary, selectively include an additive such as the dispersant, but it may not be necessary that the dispersant be present in the hydrogel HDG.

The dispersant may include, for example, at least one of alkanes, aryls, polyvinyl pyridines, polyacrylates, glycols, polyvinylidene fluorides (PVDF), polyurethanes, ketones, carbonates, benzenes, and any combination thereof.

SEM-EDS may be used to measure amounts of components included in the coating layer CTL. The amounts of components in the coating layer CTL may be measured by inductively coupled plasma mass spectrometry (ICP-MS) or inductively coupled plasma optical emission spectroscopy (ICP-OES) besides SEM-EDS.

An amount of the carbon material CBM may range from about 80 wt % to about 99 wt % relative to 100 wt % of the coating layer CTL. When the amount of the carbon material CBM satisfies the range above, there may be an increased in adhesion and conductivity between the support layer SPL and an active material layer.

An amount of the binder may range from about 0.5 wt % to about 5 wt % relative to 100 wt % of the coating layer CTL. When the amount of the binder satisfies the range above, an appropriate adhesion may be exhibited between the carbon material CBM and the hydrogel HDG.

The hydrogel HDG may be included in an amount of about 0.05 wt % to about 1 wt % relative to 100 wt % of the coating layer CTL. When the amount of the hydrogel HDG satisfies the range above, ion mobility of batteries may be effectively increased.

In the coating layer CTL, an amount ratio of the carbon material CBM to the hydrogel HDG may range from about 450 to about 2,000. When the amount ratio is within the range above, the composite substrate CPS may contribute stability to batteries.

A rechargeable lithium battery according to an example embodiment of the present disclosure may include an electrode including a composite substrate and an active material layer. In the following example embodiments of the present disclosure, a detailed description of technical features repetitive to the technical features of the rechargeable lithium battery and the composite substrate discussed with reference to FIGS. 1 to 6 will be omitted, and a difference thereof will be discussed in detail.

FIG. 7 illustrates a cross-sectional view showing an electrode according to an example embodiment of the present disclosure. An electrode according to an example embodiment of the present disclosure may correspond to the positive electrode 10 or the negative electrode 20 discussed above with reference to FIG. 1.

Referring to FIG. 7, an electrode 10 or 20 for a rechargeable lithium battery according to some example embodiments of the present disclosure may include a composite substrate CPS and an active material layer AML on the composite substrate CPS.

The composite substrate CPS may correspond to one or both of the current collectors COL1 and COL2 discussed above with reference to FIG. 1. The composite substrate CPS may include a support layer SPL, and a coating layer CTL on the support layer SPL.

The support layer SPL may be or include a metal layer. The support layer SPL may include at least one of aluminum, aluminum alloys, copper, copper alloys, nickel, nickel alloys, titanium, titanium alloys, iron, iron alloys, silver, and silver alloys.

The support layer SPL may be in contact with and connected to the positive electrode lead tab 11 or the negative electrode lead tab 21 discussed above with reference to FIG. 3.

The coating layer CTL may include a carbon material CBM and a hydrogel HDG. The coating layer CTL may be in contact with an interface of the active material layer AML. For example, the coating layer CTL and the active material layer AML may be in direct contact with each other.

The active material layer AML may be one of the positive electrode active material layer AML1 and the negative electrode active material layer AML2 discussed above with reference to FIG. 1. The active material layer AML may include at least an active material, a conductive material, and a binder. The conductive material may provide an electrode with conductivity, and any suitable conductive material that does not cause chemical change of a battery may be or include the conductive material to constitute the battery. The binder may improve attachment between active material particles to each other, and any suitable binder material that does not cause chemical change of a battery may be used as the binder to constitute the battery.

The following description will focus on some example embodiments of the present disclosure. The following example embodiments are provided to aid in understanding of the present disclosure and are not intended to limit the scope of the present disclosure.

### Embodiment 1

0.5 g of acrylic acid, 0.1 g of N,N′-methylenebisacrylamide, 0.1 g of sodium hydroxide, and 0.004 g of ammonium persulfate were added to and mixed with 10 g of water to prepare a mixed solution. 0.1 g of tetramethylenediamine was added to and mixed with the mixed solution. The obtained product was reacted for 2 hours to become gel, and the obtained gel was washed with distilled water for 3 days. A homogenizer was used such that the washed gel was grinded for 2 minutes at a speed of 14,000 rpm. The obtained grinded product was ultrasonic-wave treated for 2 minutes at a power of 25 W, and then syringe-filtered to prepare a microgel whose average size (average particle diameter, D₅₀).

0.1 wt % of hydrogel, 98.45 wt % of carbon material, and 1.45 wt % of binder were mixed to prepare a coating layer composition.

A bar coating method was used to coat the prepared coating layer composition on an aluminum foil having 12 μm in thickness, and then the aluminum foil coated with the coating layer composition was dried for 10 seconds at 180° C. to manufacture a composite substrate. A thickness of the dried coating layer was about 20 μm.

### Embodiment 2

A composite substrate was manufactured by the same method as for Embodiment 1, with a difference that 0.05 wt % of hydrogel, 98.5 wt % of carbon material, and 1.45 wt % of binder were added when the coating layer composition is prepared.

### Embodiment 3

A composite substrate was manufactured by the same method as for Embodiment 1, with a difference that 0.2 wt % of hydrogel, 98.35 wt % of carbon material, and 1.45 wt % of binder were added when the coating layer composition is prepared.

### COMPARATIVE EXAMPLE 1

A composite substrate was manufactured by the same method as for Embodiment 1, with a difference that no hydrogel was added when the coating layer composition is prepared.

### Manufacturing of Electrode for Rechargeable Lithium Battery

An electrode for a rechargeable lithium battery was manufactured by using the composite substrate obtained by Embodiments and Comparative Example of the present disclosure.

For example, 90 g of graphite, 1 g of carbon black (Super P™), and 9 g of polyvinylidene fluoride (PVDF) were dispersed in a 100 g of 1-methyl-2-pyrrolidinone (NMP) solvent to prepare an electrode slurry. Afterwards, a doctor blade was used to coat the manufactured composite substrate with the electrode slurry of 21 μm thick, and the composite substrate coated with the electrode slurry was subsequently dried to manufacture an electrode for a rechargeable lithium battery.

### EXPERIMENTAL EXAMPLE

### Fabrication of Rechargeable Lithium Battery

The manufactured electrode was used to fabricate a rechargeable lithium battery.

For example, the rechargeable lithium battery was fabricated in the form of coin cell in which the electrode manufactured by any one of the Embodiments 1-3 or the Comparative Example was used as a negative electrode, a lithium foil having a disk shape (16 mm diameter) was used as a reference electrode, nano-pore polypropylene having a disk shape (19 mm diameter) was used as a separator, and 1M LiPF₆ (ethylene carbonate (EC):ethylmethyl carbonate (EMC)=3:7) was used as an electrolyte.

### Evaluation of Cell Performance

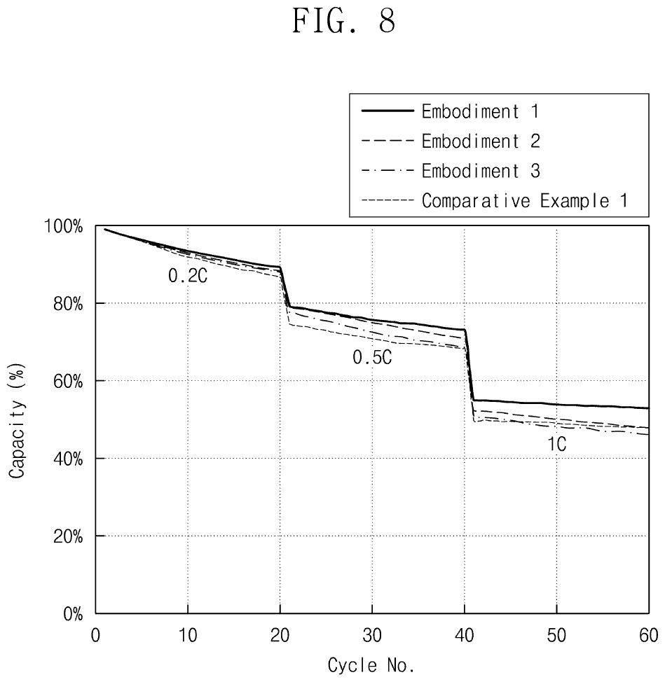

For rechargeable lithium batteries of Embodiments 1-3 and a rechargeable lithium battery of Comparative Example, experimental results of cycle characteristics and discharge tests were shown in FIG. 8 and Table 1.

The cell performance evaluation was conducted by charging and discharging using a constant current method in a charge-discharge tester. The rechargeable lithium battery was charged and discharged for 20 cycles at each C-rate under the condition of charge (0.2 C, 0.5 C, 1.0 C/4.25V, 0.01 C Cut-off, Rest 10 min) and discharge (0.33 C/2.5V Cut-off, Rest 10 min).

TABLE 1

| | Hydrogel amount | Capacity retention rate(%) | | |
|---|---|---|---|---|
| | (wt %) | 0.2 C | 0.5 C | 1.0 C |
| Embodiment 1 | 0.1 | 90.0 | 73.6 | 53.3 |
| Embodiment 2 | 0.05 | 89.2 | 71.4 | 48.0 |
| Embodiment 3 | 0.2 | 88.6 | 70.9 | 46.5 |
| Comparative Example 1 | 0 | 87.6 | 68.7 | 48.2 |

Referring to FIG. 8 and Table 1, it may be ascertained that the rechargeable battery of Embodiments 1-3 exhibit cyclic and lifetime characteristics superior to those of the rechargeable battery of Comparative Example.

In a composite substrate according to the present disclosure, a coating layer may be added with a hydrogel having an affinity for an electrolyte, and thus the composite substrate may improve in electrolyte impregnation and ion mobility. A rechargeable lithium battery including the composite substrate of the present disclosure may have desired, advantageous or improved cell performance.

Although example embodiments of the present disclosure have been discussed with reference to accompanying figures, it will be understood that various changes in form and details may be made therein without departing from the spirit and scope of the present disclosure. It will be apparent to those skilled in the art that various substitution, modifications, and changes may be thereto without departing from the scope and spirit of the present disclosure.

What is claimed is:

1. A composite substrate for a rechargeable lithium battery, the composite substrate comprising:
a support layer; and
a coating layer on the support layer, the coating layer including a carbon material and a hydrogel,
wherein the coating layer is configured to contain an electrolyte.

2. The composite substrate of claim 1, wherein the support layer comprises at least one of aluminum, aluminum alloys, copper, copper alloys, nickel, nickel alloys, titanium, titanium alloys, iron, iron alloys, silver, and silver alloys.

3. The composite substrate of claim 1, wherein the support layer has a shape of one of foils, films, sheets, meshes, nets, porous structures, foams, and non-woven fabrics.

4. The composite substrate of claim 1, wherein the carbon material comprises at least one of graphite, carbon black, acetylene black, Ketjen black, carbon fiber, carbon nano-tube, and graphene.

5. The composite substrate of claim 1, wherein an amount of the carbon material is about 80 wt % to about 99 wt % relative to 100 wt % of the coating layer.

6. The composite substrate of claim 1, wherein the hydrogel comprises a natural or synthetic hydrophilic polymer that includes at least one of hyaluronic acid, chitosan, heparin, alginate, fibrin, polyvinyl alcohol, polyethylene glycol, sodium polyacrylate, acrylate polymers, and copolymers thereof.

7. The composite substrate of claim 1, wherein an amount of the hydrogel in the coating layer is about 0.05 wt % to about 1 wt % relative to 100 wt % of the coating layer.

8. The composite substrate of claim 1, wherein, in the coating layer, an amount ratio of the carbon material to the hydrogel is in a range of about 450 to about 2,000.

9. The composite substrate of claim 1, wherein:
a thickness of the support layer is in a range of about 200 nm to about 20 μm, and
a thickness of the coating layer is in a range of about 5 μm to about 100 μm.

10. The composite substrate of claim 1, wherein the coating layer further comprises at least a binder and a dispersant.

11. A composite substrate for a rechargeable lithium battery, the composite substrate comprising:
a support layer; and
a coating layer on the support layer, the coating layer including a carbon material and a hydrogel,
wherein an amount of the carbon material is about 80 wt % to about 99 wt % relative to 100 wt % of the coating layer, and
wherein an amount of the hydrogel is about 0.05 wt % to about 1 wt % relative to 100 wt % of the coating layer.

12. The composite substrate of claim 11, wherein the support layer comprises at least one of aluminum, aluminum alloys, copper, copper alloys, nickel, nickel alloys, titanium, titanium alloys, iron, iron alloys, silver, and silver alloys.

13. The composite substrate of claim 11, wherein the support layer has a shape of one of foils, films, sheets, meshes, nets, porous structures, foams, and non-woven fabrics.

14. The composite substrate of claim 11, wherein the carbon material comprises at least one of graphite, carbon black, acetylene black, Ketjen black, carbon fiber, carbon nano-tube, and graphene.

15. The composite substrate of claim 11, wherein the hydrogel comprises a hydrophilic polymer that includes at least one of hyaluronic acid, chitosan, heparin, alginate, fibrin, polyvinyl alcohol, polyethylene glycol, sodium polyacrylate, acrylate polymers, and copolymers thereof.

16. The composite substrate of claim 11, wherein, in the coating layer, an amount ratio of the carbon material to the hydrogel is in a range of about 450 to about 2,000.

17. The composite substrate of claim 11, wherein:
a thickness of the support layer is in a range of about 200 nm to about 20 μm, and
a thickness of the coating layer is in a range of about 5 μm to about 100 μm.

18. The composite substrate of claim 11, wherein the coating layer further comprises at least a binder and a dispersant.

19. A rechargeable lithium battery comprising an electrode that includes a composite substrate and an active material layer on the composite substrate,
wherein the composite substrate includes a support layer and a coating layer on the support layer, and
wherein the coating layer includes a carbon material and a hydrogel.

20. The rechargeable lithium battery of claim 19, wherein the active material layer comprises at least an active material, a conductive material, and a binder.
